(19) United States
(12) Patent Application Publication
(10) Pub. No.: US 2006/0165415 A1
(43) Pub. Date: Jul. 27, 2006

(54) Communication cable

(75) Inventors: Kimio Nagasaka, Nirasaki-shi (JP); Akira Miyamae, Fujimi-machi (JP); Paul Patterson, Hillsboro, OR (US)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/038,537

(22) Filed: Jan. 21, 2005

(51) Int. Cl. H04B 10/00

(52) U.S. Cl. 398/116

(57) ABSTRACT

To provide the communication cable that enables to replace the communication media with an optical signal and increase the communication speed, while assuring the compatibility with the already-widespread telecommunication method. A communication cable used for connecting a plurality of electronic appliances, as well as for conducting communication of information with standardized telecommunication method, wherein the electric signal that is output from one of the electronic appliance is converted to the optical signal with one of the optical module, and is transmitted to the other optical module via the optical transmission medium, and then the optical signal is converted back to the electric signal with the other optical module and is output to the other electric appliance.

### BACKGROUND

The present invention relates to a communication cable, used for interconnecting a plurality of electronic appliances (for example, personal computers, etc.), as well as for conducting communication with standardized telecommunication method.

In order to conduct a communication of information between electronic appliances such as personal computers, etc., various kinds of telecommunication methods that use electric signals as media are standardized. As for such telecommunication methods, 10BASE-T, 100BASE-T, etc. for example, based on IEEE802.3 are known, and are used for communication of information between computers, or between computers and peripheral devices (for example, a printer, etc.). In such telecommunication methods, specifications of the format of the electric signal being sent or received (for example, a frame type or transmission speed), the physical characteristics of a cable being used, or the shape of the connector applied on the end of a cable are standardized.

As the quantity of the information communicated has increased in the recent years, there is an increasing need for further high-speed communication. However, in the above-mentioned communication methods using electric signals as media, as the communication speed increases, various types of disadvantages emerge, such as the occurrence of cross talk among the signal wires, signaling level attenuation due to impedance mismatch, or limitation in cable length caused by the higher frequency of the transmission signal. For this reason, in the current level of technology, the implementation of high-speed communication over 1 Gbps with a commercially reasonable cost is said to be difficult. In light of such background, technologies to replace the electric signals used as media with an optical signal are examined. Such technologies are described, for example, in the technical magazine Nikkei Electronics, December 3 edition, Year 2001, published by Nikkei Business Publications, Inc. (non-patent document 1).

[Non-Patent Document 1] Nikkei Electronics, December 3 edition, Year 2001, published by Nikkei Business Publications, Inc. (pages 112 to 122).

### SUMMARY

From a perspective of effective utilization of existing facilities, when shifting from electric signals to optical signals, a high level of compatibility with the above-mentioned telecommunication methods is desired.

The present invention aims to provide the communication cable that enables to replace the communication media with an optical signal and increase the communication speed, while assuring the compatibility with the already-widespread telecommunication method.

The present invention is a communication cable used for connecting a plurality of electronic appliances, as well as for conducting communication of information with standardized telecommunication method, the communication cable comprising: an optical transmission medium; an optical module, having a function either to convert an electric signal that is based on the telecommunication method to an optical signal, or to convert the optical signal to the electric signal, respectively applied both on one end and on the other end of the optical transmission medium; an optical plug, having a function to optically connect the optical transmission medium and the optical module, respectively applied on both ends of the optical transmission medium; an electrode terminal, electrically connected to the optical module, for serving as a connecting point to electrically interconnect between the optical module and the electronic appliance; a housing, having a shape set by the telecommunication method, and formed to self-contain the optical plug, the optical module, and the electrode terminal; wherein the electric signal that is output from one of the electronic appliance is converted to the optical signal with one of the optical module, and is transmitted to the other optical module via the optical transmission medium, and then the optical signal is converted back to the electric signal with the other optical module and is output to the other electric appliance.

In the afore mentioned structure, when the electric signal that is compatible with the standards compliant with telecommunication method or the already widespread method (including upward compatibility) is transmitted, the electric signal is converted into an optical signal and transmitted from the electronic appliance, and then restored to the electric signal compatible with prescribed standard and is output to the electronic appliance side of the communication target. More specifically, the communication cable in the present invention conducts the input and output of the signal at its both ends with an electric signal, and conducts the signal transmission from one end to the other with an optical signal. Consequently, it can be handled in the same manner as that of the communication cable composed of an electric line such as a coaxial line in a conventional communication method with an electric signal. Furthermore, since the optical signal is used as a medium, there are fewer factors to inhibit the increase of communication speed in comparison to the case of using an electric signal as a medium. Thus, by using the communication cable in the present invention, it is possible to replace the communication media with an optical signal and increase the communication speed, while assuring the compatibility with the already-widespread telecommunication method.

Desirably, the optical module is structured including: a transparent substrate having an optical transparency to the wavelength of the optical signal; an optical element, placed on one surface of the transparent substrate, either for receiving a supply of driving signal consisting of either a current or a voltage and emitting the optical signal to the other surface of the transparent substrate, or for outputting a current or a voltage that corresponds to the strength of the optical signal inserted from the other surface of the transparent substrate; and a reflector plate, placed on the other side of the transparent substrate, either for modifying the course of the optical signal emitted from the optical element by almost 90 degrees and leading to the optical transmission media, or for modifying the course of the optical signal emitted from the optical transmission medium by almost 90 degrees and leading to the optical element. Moreover, the optical module may be structured to be provided with a circuit chip, that either controls the emission of the optical element according to the electric signal, or generates the electric signal according to the current or voltage that is output from the optical element.

In the afore mentioned structure, it is easy to miniaturize the optical module, and even when there is a necessity to make the volume of the housing relatively small, it is possible to house the optical module easily within that housing.

Desirably, the optical module is further provided with a lens, either for collecting the optical signal emitted from the optical element and leading to the reflector plate, or for collecting the optical signal that is emitted from the optical transmission media and is reflected by the reflector plate and leading to the optical element.

This makes it possible to improve the efficiency of optical coupling.

### BRIEF DESCRIPTION OF THE DRAWINGS

FIG. 1 is a sectional drawing that describes the structure of the communication cable of one of the embodiments;

FIG. 2 is a drawing that describes the example of the usage of the communication cable;

FIG. 3 is a drawing that describes the structure of the optical plug in detail; and

FIG. 4 is a drawing that describes the structure of the optical module in detail.

### DETAILED DESCRIPTION OF EMBODIMENTS

An embodiment of the present invention will now be described.

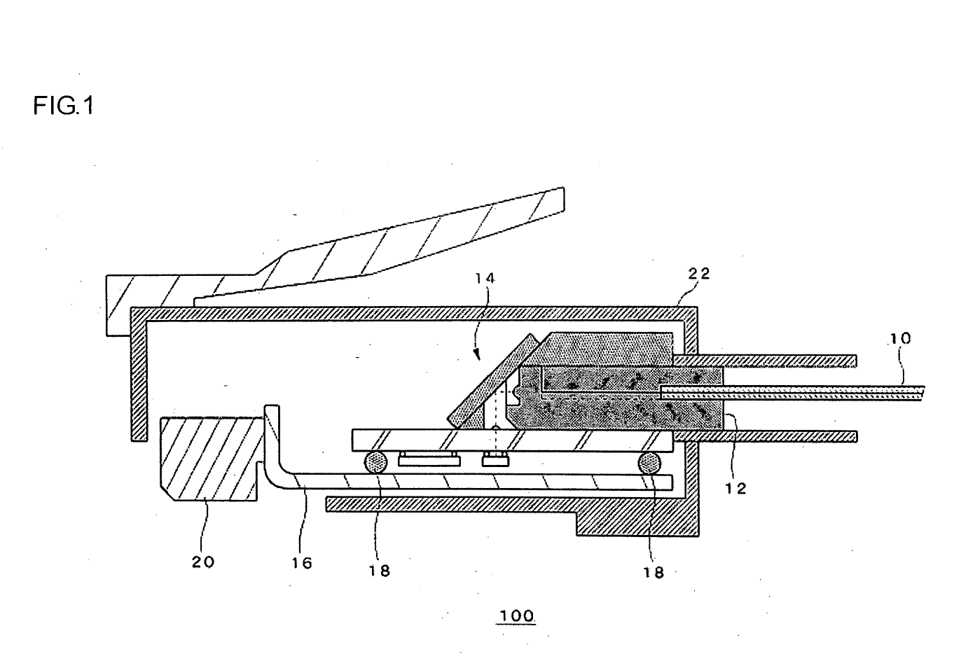

FIG. 1 is a sectional drawing that describes the structure of the communication cable of the certain embodiment. A communication cable 100 shown in FIG. 1 is structured including: a tape-filter (an optical transmission medium) 10 formed with an optical fiber in a shape of tape; an optical plug 12 applied on the both ends of this tape-fiber 10; an optical module 14 that serves a function of inter converting an electric signal and an optical signal; a wiring substrate 16 having a prescribed wiring pattern; a ball solder 18 that serves as an electrical connector of the wiring substrate 16 and the optical module 14; an electrode terminal 20 that is electrically connected to the wiring substrate 16; and a housing 22 formed to self-contain the optical plug 12, the optical module 14, and the electrode terminal 20, etc. In FIG. 1, only the one end of the communication cable 100 is shown, but the same structure is applied to the other end as well.

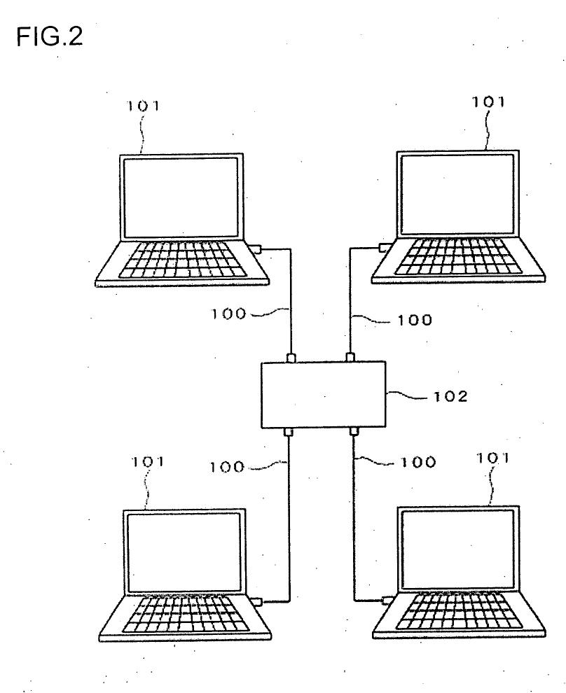

FIG. 2 is a drawing to describe the example of the usage of the communication cable in the present embodiment. In FIG. 2, each of the plurality of personal computers 101 is connected to a hub 102 using the communication cable 100 in the present embodiment, and a system wherein a network (so called LAN) is build so as to be able to conduct a standardized communication of information, based on the telecommunication method such as IEEE 802.3 based 100BASE-T, etc. is shown schematically. In the system shown, the communication cable 100 in the present embodiment serves the following functions: To receive an electric signal that electronic appliances such as the personal computer 101, etc. pass so as to conduct a communication based on the afore mentioned standardized telecommunication method; to convert the signal to an optical signal with the optical module 14 that is on the one end of the tape-fiber 10; to transmit the signal to the optical module 14 that is on the other end of the tape-fiber 10; to convert the signal back again to the electric signal that is compatible with the prescribed standard with the optical module 14 on the other end, and to output it to the target electronic appliance (in the present example, to the hub 102).

Hereafter, the structure of the communication cable 100 in the present embodiment is described further in detail while referring to FIG. 1.

The optical plug 12 has a function to connect the tape-fiber 10 and the optical module 14 optically, and it is applied to each end of the tape-fiber 10. The detailed structure of this optical plug 12 will be described later.

The optical module 14 is provided with following functions: To convert an electric signal based on the prescribed telecommunication method that electronic appliances such as the personal computer 101, etc. pass to an optical signal and insert it to the tape-fiber 10; and to convert an optical signal sent via the tape-fiber 10 from the other optical module 14, to an electric signal based on the above-mentioned telecommunication method, and to output it, so that the above-mentioned electronic appliances such as the personal computer 101, etc. are able to receive it. The detailed structure of this optical module 14 will be described later.

The wiring substrate 16 has a wiring with a prescribed pattern, and is connected electrically to the optical module 14 via the ball solder 18, as well as to the electrode terminal 20 at the L-shaped part applied on one end, and serves a function of electrically connecting the electrode terminal 20 and the optical module 14. For this wiring substrate 16, a flexible printed-circuit board (FPC), for example, is appropriately used.

The electrode terminal 20 is placed on one end of the wiring substrate 16, and is connected electrically with the optical module 14 via the wiring substrate 16. It becomes a connecting point to electrically interconnect between the optical module 14 and the electronic appliance such as the above mentioned personal computer 101, etc.

The housing 22 has a shape prescribed in standardized telecommunication methods such as 100BASE-T, etc., based on IEEE802.3 standard, and is formed to self-contain the optical plug 12, the optical module 14, the electrode terminal 20, etc. On the side of the electronic appliance such as the above-mentioned personal computer 101, etc., a connecting slot that corresponds to the shape of this housing 33 is applied. By inserting this housing part 22 partially or entirely, an electrode terminal applied inside the connecting slot (not shown) on the side of the electronic appliance comes in contact with the above-mentioned electrode terminal 20.

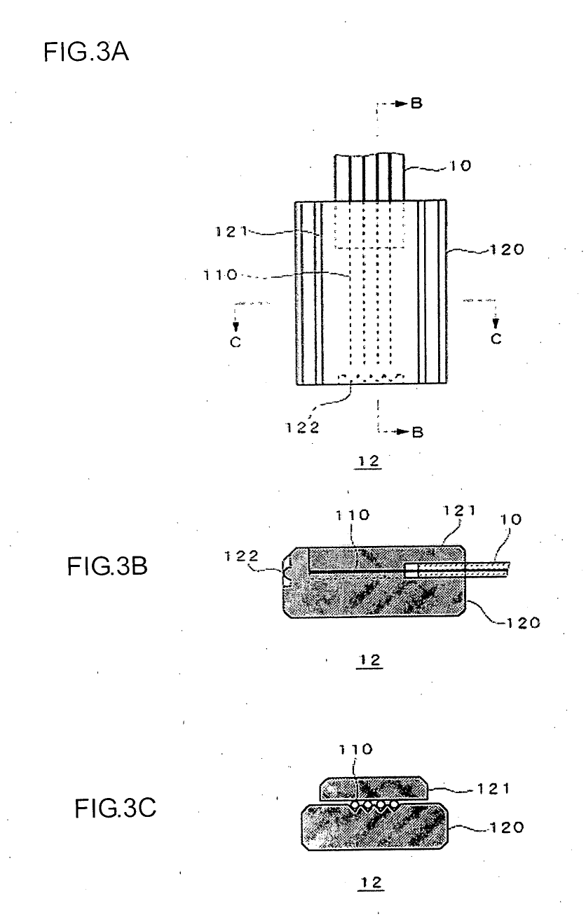

FIG. 3 is a drawing describing the structure of the optical plug 12 in detail. FIG. 3(A) represents a top view of the optical plug 12, FIG. 3(B) represents a sectional drawing of the section B-B shown in FIG. 3(A), and FIG. 3(C) represents a sectional drawing of the section C-C shown in FIG. 3(A), respectively. As shown in FIG. 3, the optical plug 12 is structured, including a base 120, an upper panel 121, and a plurality of lenses 122. As shown in FIG. 3(C), the optical plug 12 has a structure where a fiber core 110 of the tape-fiber 10 is placed along the V-shaped channel that the base 120 has, and above it, the upper panel 121 is placed, sandwiching the fiber core 110 with the upper panel 121 and the base 120. 4 lenses 122 are formed together with the base 120, and placed so that the fiber core 110 and the optical axis almost match.

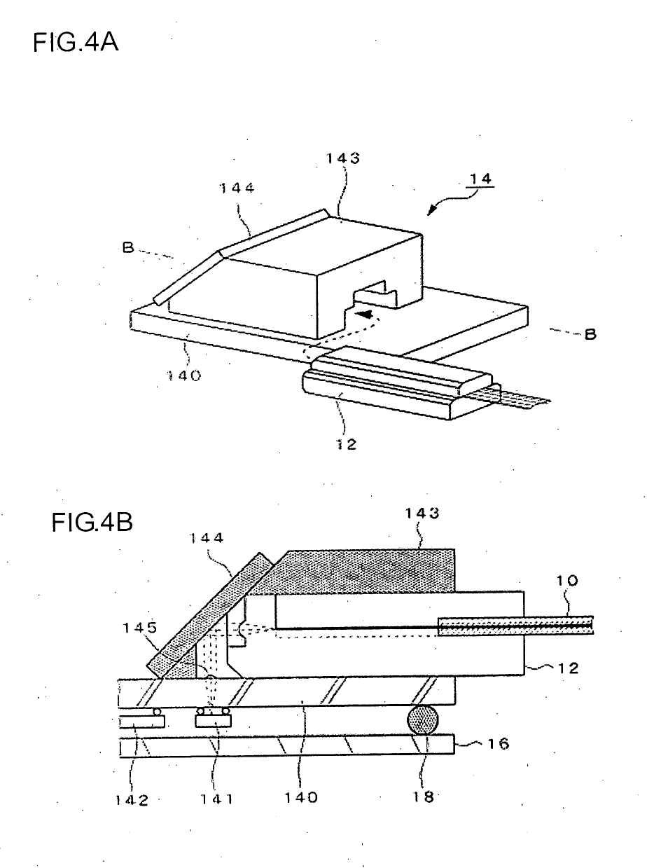

FIG. 4 is a drawing that describes the structure of the optical module 14 in detail. FIG. 4(A) represents the appearance of the optical module 14 with an oblique drawing, and FIG. 4(B) is a sectional drawing of the section B-B shown in FIG. 4(A). As shown in FIG. 4, the optical module 14 is structured, including a transparent substrate 140, an optical element 141, a circuit chip 142, an optic socket 143, a reflector plate 144, a lens 145.

The transparent substrate 140 has an optical transparency to the wavelength of light used, and supports each element constructing the optical module 14. For example, in the case where the wavelength of the optical signal emitted from the optical element 141 or received at the optical element 141 is visible-light or close to that value (for example, 850 nm), it is desirable to structure the transparent substrate 140 with material such as glass or plastic.

The optical element 141 receives supplies of driving signals (current or voltage) from a circuit chip 142 and emits optical signals, or generates output signals (current or voltage) corresponding to the strength of the signal light received through the transparent substrate 140, and is placed on the prescribed location on one side of the transparent substrate 140, with its emitting surface or receiving surface toward the transparent substrate 140. For example, for the optical element 141 used on the information sending-side, emitting optics such as Vertical-Cavity Surface-Emitting Laser (Surface-Emitting Laser) or the like are raised, and for the optical element 141 used on the information receiving-side, receiving optics such as photodiode, etc. are raised.

The circuit chip 142 includes a driver and the like for driving the optical element 141, and is placed on the prescribed location on one side of the transparent substrate 140. This circuit chip 142 is connected to the optical element 141 via a wiring film (not shown) structured on the transparent substrate 140. Moreover, when necessary, it is connected to another circuit element (not shown) or circuit chip, etc. This circuit chip 142 serves a function of either controlling the emission of the optical element 141, according to the electric signals that are passed from electronic appliance such as the personal computer 101 and a like as well as received via the electrode terminal 20 or via the wiring substrate 16, etc., or generating (restoring) the electric signal that the electric appliance is able to receive, according to the output signal (current or voltage) from the optical element 141. The function the circuit chip 142 serves may be delegated to the optical element 141, in which case it is possible to omit the circuit chip 142.

The optic socket 143 is equipped with a hole so as to be joined with the optical plug 12, and is placed on the other side of the transparent substrate 140. This optic socket 143 is provided with the optical plug 12, and serves a function to optically couple one end of the tape-fiber 10 supported with the optical plug 12 and the optical element 141, and is formed using, for example, glass or plastic.

The reflector plate 144 is attached onto the optic socket 143, and is placed on the other side of the transparent substrate 140. It modifies the course of the optical signal emitted from the optical element 141 by almost 90 degrees and leads to the tape-fiber 10, or modifies the course of the optical signal emitted from the tape-fiber 10 by almost 90 degrees and leads to the optical element 141. This reflector plate 144 is placed almost 45 degrees to the optical axis (the main transmission direction of the signal light) of the optical element 141.

The lens 145 serves a function to either collect optical signals emitted from the optical element 141 and lead to the reflector plate 144; or to collect optical signals that are emitted from the tape-fiber 10 and are reflected by the reflector plate 144, and lead to the optical element 141.

As previously described, according to the communication cable 100 in the present embodiment, when the electric signal that is compatible with the standards compliant with the telecommunication method or the method already widespread (including upward compatibility) is transmitted, the electric signal is converted into an optical signal and transmitted from the electronic appliance, such as the personal computer 101, and is then restored to the electric signal compatible with the prescribed standard and is output to the electronic appliance side of the communication target. More specifically, the communication cable 100 in the present embodiment conducts the input and output of the signal at its both ends with electric signal, and conducts the signal transmission from one end to the other with an optical signal. Consequently, it can be handled in the same manner as that of the communication cable composed of an electric line such as a coaxial line in a conventional communication method with an electric signal. Furthermore, since the optical signal is used as a medium, there are fewer factors to inhibit the increase of communication speed in comparison to the case of using an electric signal as a medium. Thus, by using the communication cable 100 in the present embodiment, it is possible to replace the communication media with an optical signal and increase the communication speed, while assuring the compatibility with the already-widespread telecommunication method.

Moreover, the optical module 14 in the present embodiment is structured to reflect a signal light emitted from the optical element 141, as well as a signal light emitted from the tape-fiber 10, by almost 90 degrees, so as to provide optical coupling. Hence, it is possible to place the longitudinal direction of the tape-fiber 10 along the surface of the transparent substrate 140, and it is easier to miniaturize. In the optical module 14 of the present example, space reduction may be provided specifically in the thickness of the transparent substrate 140, thus it is possible to house the optical module easily in the relatively small volume housing 22, yet keeping the standardized shape.

The present invention shall not be limited to the each content of the present embodiments mentioned above, and within the main scope of the present invention, it is possible to embody the present invention with other kinds of modifications. For example, in the above mentioned embodiment, IEEE802.3 standard 100 BASE-T is displayed as an example of the standardized telecommunication method. However, it is possible to make the embodiment compatible with communication of information based on other various standardized telecommunication methods, such as USB and IEEE1394, etc.

What is claimed is:

1. A communication cable coupling a plurality of electronic appliances together, and conducting communication of information with standardized telecommunication method, the communication cable comprising:
an optical transmission medium;
a pair of optical modules, converting an electric signal based on the telecommunication method to an optical signal, or converting the optical signal to the electric signal, and installed both on one end and on the other end of the optical transmission medium;
an optical plug, optically coupling the optical transmission medium to the optical module, and installed on both ends of the optical transmission medium;
an electrode terminal, electrically coupled to the optical module, that serves as a coupling point to electrically interconnect between the optical module and the electronic appliance;
a housing, having a shape set by the telecommunication method, and formed to self-contain the optical plug, the optical module, and the electrode terminal;
wherein the electric signal that is output from one of the electronic appliances is converted to the optical signal with one of the optical modules, and is transmitted to another of the optical modules via the optical transmission medium, and then the optical signal is converted back to the electric signal with another of the optical modules and is output to the another of the electric appliances.

2. The communication cable according to claim 1, wherein the optical module includes:
a transparent substrate having an optical transparency to the wavelength of the optical signal;
an optical element, placed on one surface of the transparent substrate, that receives a current or a voltage and emits the optical signal to the other surface of the transparent substrate, or outputs a current or a voltage corresponding to the strength of the optical signal which is incident from the other surface of the transparent substrate; and
a reflector plate, placed on the other side of the transparent substrate, that modifies the course of the optical signal emitted from the optical element by almost 90 degrees and leads the optical signal to the optical transmission media, or that modifies the course of the optical signal emitted from the optical transmission medium by almost 90 degrees and leads the optical signal to the optical element.

3. The communication cable according to claim 2, wherein the optical module further comprising a lens, that collects the optical signal emitted from the optical element and leads the optical signal to the reflector plate, or that collects the optical signal, emitted from the optical transmission media and reflected by the reflector plate, and leads the optical signal to the optical element.

4. A communication cable coupling a plurality of electronic appliances together, and conducting communication of information with standardized telecommunication method, the communication cable comprising:
an optical transmission medium;
a optical modules, converting an electric signal based on the telecommunication method to an optical signal, and installed on an end of the optical transmission medium;
an optical plug, optically coupling the optical transmission medium to the optical module, and installed on the end of the optical transmission medium;
an electrode terminal, electrically coupled to the optical module, that serves as a coupling point to electrically interconnect between the optical module and the electronic appliance;
a housing, having a shape set by the telecommunication method, and formed to self-contain the optical plug, the optical module, and the electrode terminal;
wherein the electric signal that is output from the electronic appliances being converted to the optical signal with the optical modules, and is transmitted via the optical transmission medium.

5. A communication cable coupling a plurality of electronic appliances together, and conducting communication of information with standardized telecommunication method, the communication cable comprising:
an optical transmission medium;
a optical modules, converting the optical signal to the electric signal, and installed on an end of the optical transmission medium;
an optical plug, optically coupling the optical transmission medium to the optical module, and installed the ends of the optical transmission medium;
an electrode terminal, electrically coupled to the optical module, that serves as a coupling point to electrically interconnect between the optical module and the electronic appliance;
a housing, having a shape set by the telecommunication method, and formed to self-contain the optical plug, the optical module, and the electrode terminal;
wherein the optical signal that is transmitted via the optical transmission medium is converted back to the electric signal with the optical modules and is output to the electric appliances.
